(19) United States
(12) Patent Application Publication
(10) Pub. No.: US 2010/0160102 A1
(43) Pub. Date: Jun. 24, 2010

(54) CHROMIUM(VI)-FREE COMPOSITION FOR PROTECTION OF A GALVANIZED METAL SURFACE AGAINST CORROSION, PROCESS FOR PRODUCING IT AND PULLEY

(75) Inventors: Bertram Haag, Uhlfeld (DE); Sergej Vogelsang, Wilhelmsdorf (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/161,009

(22) PCT Filed: Dec. 13, 2006
(86) PCT No.: PCT/EP2006/069669

§ 371 Date: Jul. 16, 2008

(30) Foreign Application Priority Data
Jan. 16, 2006 (DE) 10 2006 002 224.6

(51) Int. Cl. F16H 55/38; B32B 15/04; B05D 1/18; B05D 3/02; B05D 3/00

(52) U.S. Cl. 474/166; 428/615; 428/627; 428/630; 428/632; 427/435; 427/372.2; 427/352; 427/436

(57) ABSTRACT

An arrangement for protecting a substrate against corrosion, including a substrate, in particular a metallic substrate, and an electrically conductive corrosion protection layer applied to the substrate to protect the substrate against corrosion, which layer has a zinc-containing layer which has been applied to the substrate and has a passivation layer which has been applied to the zinc-containing layer for passivating the zinc-containing layer and contains many particles of hard material which have such a nature that the particles of hard material increase the coefficient of friction on a free surface of the passivation layer compared to a conversion layer without particles of hard material but leave the electrical conductivity of the passivation layer essentially unchanged. The invention further relates to a process for producing such an arrangement and a pulley.

### BACKGROUND

The present invention relates to an arrangement for protecting a substrate from corrosion, to a process for producing such an arrangement, and also to a pulley.

Components made from steel or a steel alloy typically experience corrosion especially in an environment of elevated temperature, such as, for example, in an engine compartment. For protection from corrosion, such components made from steel or a steel alloy are typically coated with a corrosion protection layer made from zinc or a zinc alloy. Because this zinc-bearing layer can also corrode, for additional passivation, a so-called passivation layer or conversion layer is applied on the surface of this zinc layer or zinc alloy. This is usually made from a chromate coating, which can contain, for example, chromium (III) or chromium (VI). However, corrosion-protection layers based on, for example, Zr or Ti, can also be used.

For additional protection of the passivation layer, this can be coated with a so-called top-coat, a polymer compound, for example, polyacrylate or polyethylene, or an organic or inorganic lacquer.

Below, the invention and also the problem forming the basis of the invention will be explained with reference to a free-running pulley for a generator, but without limiting the invention to this example. For the operation of a generator through the use of a generator free-running pulley, a belt made from a polymer material runs over and drives the generator free-running pulley. This method can produce an electrostatic charge due to the friction contact between the belt and the pulley. This charge can damage electric or electronic parts located nearby when there is a more or less spontaneous, uncontrolled discharge. Therefore, there is the need to discharge this electrostatic charge in a controlled way. However, discharge of the electrostatic charge is possible only by electrically conductive regions of the generator free-running pulley, so that the generator free-running pulley must be electrically conductive as much as possible in the region of the surface in friction contact with the belt.

For the operation of a generator free-running pulley, it is also important that a relatively high friction effect between the generator free-running pulley and the corresponding belt is present. Therefore, it is possible to reduce the slip between the belt pulley and the belt and thus to achieve a better driving behavior of the belt for the same belt tension or the same driving behavior for a reduced belt tension. The use of a reduced belt tension for the same driving behavior results in a longer service life of the belt. This leads, overall, to lower costs in the preparation and operation of the generator free-running pulley.

It is problematic, however, that the coatings, such as the top coat or lacquer coating, typically applied for improving the corrosion protection or the coefficient of friction, are not electrically conductive and therefore cannot discharge electric charges. The use of all-plastic components as an alternative also allows no discharge of the charges.

Therefore, there is the need for a surface coating for a generator free-running pulley, wherein this coating is both electrically conductive and also simultaneously features a good coefficient of friction at the surface.

### SUMMARY

The objective of the present invention is to provide a coating, which is electrically conductive and which features an increased coefficient of friction.

According to the invention, this objective is met by a coating with the features of the invention, by a pulley with the features of the invention, and/or by a method for generating such a coating.

According to a first aspect, the present invention relates to an arrangement for protecting a substrate from corrosion, with the substrate, in particular, a metallic substrate, having an electrically conductive corrosion-protection layer applied for protecting the substrate from corrosion, wherein this corrosion-protection layer has a zinc-bearing layer applied to the substrate and a passivation layer applied to the zinc-bearing layer for passivating the zinc-bearing layer, wherein this passivation layer has a plurality of hard-material particles, which are created in such a way that due to the hard-material particles, the coefficient of friction of a free surface of the passivation layer is increased compared with a passivation layer without hard-material particles, but the electrical conductivity of the passivation layer remains essentially the same.

Below, a layer or a material made from zinc or a zinc alloy should be understood as the zinc-bearing layer or as the zinc-bearing material. Also, a layer made from a zinc alloy should be included with references to a zinc layer. The terms passivation layer and conversion layer are used synonymously in this application.

The idea forming the basis of the present invention is that, through the use of hard-material particles in a passivation layer, the coefficient of friction of the passivation layer is to be increased compared with polymer materials, such as, for example, V-type belts or rubber rollers. Simultaneously, the wear both of the passivation layer and also of the polymer materials coming in contact can be reduced. In addition, the electrical conductivity of the surface, in particular, of the passivation layer, can be maintained, in order to be able to discharge electrostatic charge building up from the friction between the passivation layer and polymer material. Consequently, through the use of hard-material particles in the passivation layer, the electrical properties of the surface are influenced not at all or at most insignificantly, but the strength and, in particular, the coefficient of friction is improved compared with other materials.

According to a second aspect, the present invention relates to a pulley with a metallic body, which has a hub for the precise-fit holding of a shaft, with an outer surface on its periphery for receiving a belt made from a polymer material, with an arrangement according to the first aspect of the invention, wherein the substrate of the arrangement is a component of the metallic body at least in the region of the outer surface.

The application of the hard material particle-containing passivation layer allows the preparation of a pulley, which exhibits lower or no electrostatic charge. Here, the pulley exhibits improved driving behavior due to the increased coefficient of friction. Therefore, the force transfer is increased for the same belt tension or a lower belt tension can be selected, in order to achieve the same force transfer for a passivation layer without hard-material particles.

According to another aspect, the present invention relates to a method for generating a passivation layer, in particular, for an arrangement according to the first aspect of the present invention, with the steps:
(a) preparation of a passivation bath, which has hard-material particles,
(b) preparation of a substrate, on whose surface a zinc-bearing layer is applied,
(c) immersion of the substrate in the passivation bath, by which, on the surface of the zinc-bearing layer, a passivation layer is formed, which has a plurality of hard-material particles, wherein the passivation layer formed in this way is created such that, due to the hard-material particles, the coefficient of friction of a free surface of the passivation layer is increased compared with a passivation layer without hard-material particles, but the electrical conductivity of the conversion layer remains essentially the same.

The hard-material particles integrated in the conversion layer are embedded in the conversion layer during the generation of this layer. Due to the size of the hard-material particles, these remain slightly suspended in the passivation bath and are integrated into this conversion layer with the precipitation of the conversion layer. Due to the method according to the invention, the hard-material particles are advantageously embedded in the conversion layer in a homogeneous way.

Advantageous constructions, refinements, and improvements of the concept of the invention emerge from the additional subordinate claims and also from the description with reference to the drawing.

According to one preferred refinement, the hard-material particles are constructed as nanoparticles. According to another preferred refinement, the size of the nanoparticles is in the range from 1 to 1000 nm, preferably in the range from 2 to 100 nm, more preferably in the range from 8 to 50 nm, and especially in the range from 10 to 20 nm. Due to the size of the nanoparticles, these can be easily introduced into the passivation bath and form a suspension. The size of the particles is preferably less than the thickness of the passivation layer to be generated. Thus, a good particle distribution in the passivation layer is achieved. The size of the particles is selected such that they project somewhat out of the passivation layer. Therefore, the surface of the passivation layer is changed such that a better adhesion behavior is generated.

According to another preferred refinement, the hard-material particles are made from an inorganic hard material. According to yet another preferred refinement, the hard-material particles have a Mohs' hardness of at least 5. Preferred materials for the hard-material particles are inorganic carbides, oxides, diamond, and/or nitrides, in particular, SiO₂, SiC, WC, Al₂O₃, and/or BN, or also their mixtures. However, many other materials with the same or similar hardness and these properties are also conceivable.

According to yet another preferred refinement, the passivation layer has a thickness of at most 800 nm, preferably in the range from 50 to 500 nm, and, in particular, from 100 to 200 nm. The zinc-bearing layer can have a thickness of greater than 0.5 μm, preferably greater than 100 μm.

According to a preferred construction, the passivation layer is constructed as a chromium-bearing passivation layer, which contains chromium.

According to a preferred refinement of the second aspect of the present invention, the belt pulley is constructed as a V-ribbed pulley or as a straight disk.

According to a different preferred refinement, the substrate is made from steel or a steel alloy.

According to a preferred refinement of the third aspect of the present invention, hard-material particles are introduced into a passivation solution for generating the passivation bath.

According to a different preferred refinement, the passivation layer is flushed in the passivation bath in another step (d) after the passivation layer is generated. The flushing can be performed according to a different preferred refinement of the present invention before or after a drying step. It is also possible to flush the passivation layer both before and also after a drying step of this layer.

According to a preferred construction, the passivation bath contains a chromium-bearing passivation solution.

According to a different preferred refinement, the chromating bath is constructed essentially free from chromium (VI). Due to the use of chromium (III) in the passivation bath, a conversion layer can be produced, which is essentially free from chromium (VI). Additional possibilities are, for example, the use of passivations based on Zr or Ti.

### BRIEF DESCRIPTION OF THE DRAWINGS

The invention will be explained in more detail below using embodiments with reference to the enclosed figures of the drawings. In the figures:

FIG. 1 is a first, general embodiment of an arrangement according to the invention for protecting a substrate from corrosion,

FIG. 2 in the sub-figures a) to d), show a method for producing a corrosion-protection layer according to the invention,

FIG. 3 is a perspective view of a generator free-running pulley,

FIG. 4 is a cross-sectional view of the generator free-running pulley from FIG. 3 with a corrosion-protection layer according to the invention.

### DETAILED DESCRIPTION OF THE PREFERRED EMBODIMENTS

In the figures of the drawing, identical and functionally identical elements and features are designated with the same reference symbols—if not indicated otherwise.

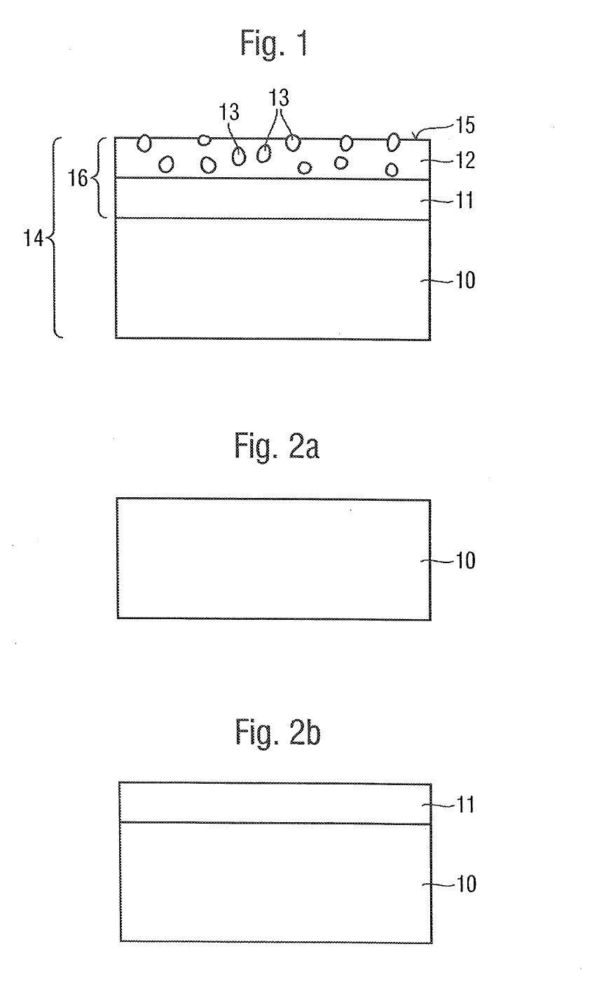

FIG. 1 shows a first, general embodiment of an arrangement according to the invention for the corrosion protection of a substrate. The arrangement is here designated with reference symbols 14. The arrangement 14 comprises a substrate 10 with the corrosion-protection layer 16 deposited on this substrate. The substrate 10 can be steel or a steel alloy.

On the substrate 10, a zinc-bearing layer 11 is deposited as a component of the corrosion-protection layer 16. The zinc-bearing layer 11 can be deposited galvanically or, for example, using a hot-dip galvanizing method. The thickness of the layer 11 can be selected more or less freely. For example, the layer thickness of the layer 11 equals greater than 0.5 μm and advantageously a few μm.

On the layer 11, a passivation layer 12 is similarly deposited as a component of the corrosion protection layer 16. The passivation layer 12 can contain Zr, Ti, chromium (III), or also chromium (VI). The passivation layer 12 contains, according to the invention, nanoparticles 13, which can be constructed, for example, as SiO₂ nanoparticles. In other embodiments, the nanoparticles 13 can be made, for example, from Al₂O₃ or SiC. At a surface 15 of the chromating layer 12 and thus the corrosion-protection layer 16, a few of the nanoparticles 13 project somewhat out of the surface 15, by which a somewhat roughened surface 15 is formed. Therefore, the surface 15 of the corrosion-protection layer 16 is changed in such a way that increased friction is achieved and with this an improved driving effect compared with a polymer material of a belt.

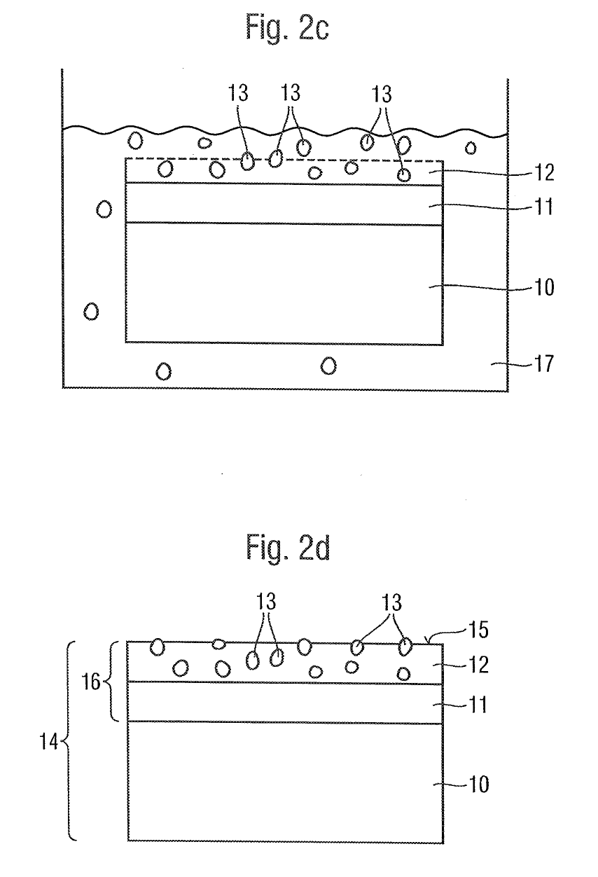

In FIG. 2, a method for generating a passivation layer 16 according to the invention is shown.
First a substrate 10 is prepared (FIG. 2a).
On this substrate 10, a zinc-bearing layer 11 is deposited (FIG. 2b).
The arrangement produced in this way is immersed in a passivation bath 17. The passivation bath 17 can be heated, for example, to 30° C. The passivation layer 17 contains nanoparticles 13. These are embedded into the conversion layer 12 during the deposition of the conversion layer 12 on the zinc-bearing layer 11 in the passivation bath 17 (FIG. 2c).
Then the arrangement 14 produced in this way is removed from the passivation bath 17, flushed, and dried (FIG. 2d).

Below, an actual example for generating the conversion layer 12 is shown.

In a 5-liter beaker glass, 150 ml/l of the passivation solution lanthane TR 175 part A and 90 ml/l of the nanoparticle-bearing solution lanthane TR 175 part B of the commercially available product from the company Coventya GmbH & Co. KG are mixed in deionized water. The pH value of the solution was adjusted with HNO₃ to pH=2.0. The temperature of the solution equaled 30° C. A free-running pulley coated galvanically with a ZnFe alloy is immersed in this solution while the solution is stirred for 75 s. After repeated immersion in demineralized water, the component is dried at 70° C. Here, a corrosion-protection layer 16 provided with nanoparticles is generated.

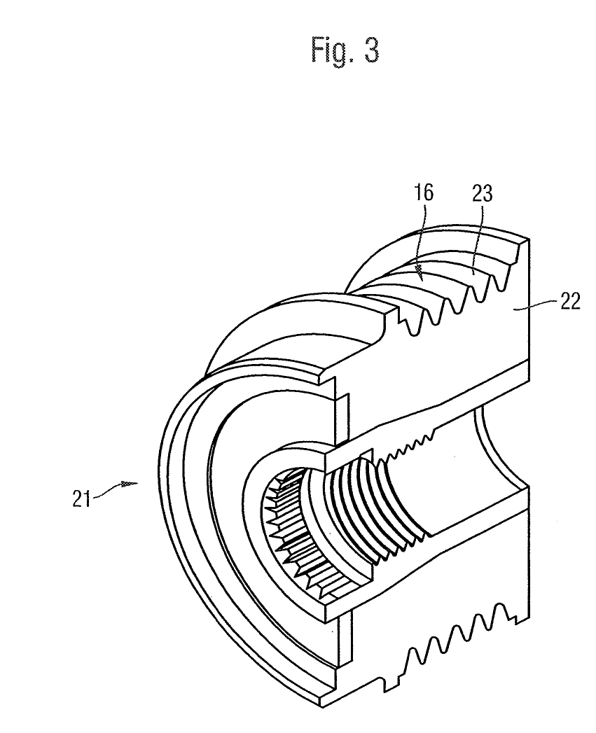

FIG. 3 shows a perspective view of a generator free-running pulley 21, on whose disk body 22, V-type ribs 23 are formed. The V-type ribs 23 are constructed in such a way that a V-ribbed belt can be deflected over the outer periphery of the generator free-running pulley 21. The surface of the V-type ribs 23 of the outer periphery of the generator free-running pulley is provided with a corrosion-protection layer 16 according to the present invention.

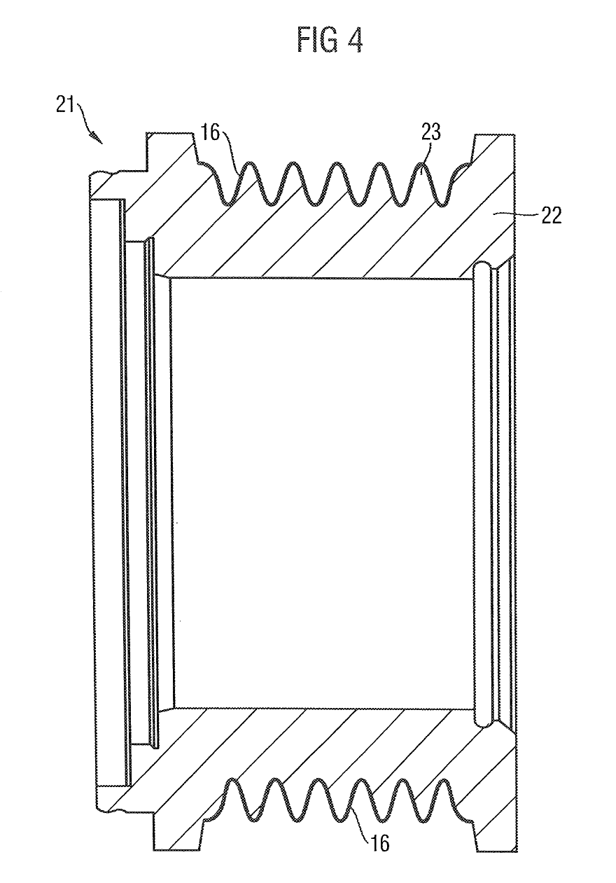

FIG. 4 shows the generator free-running pulley from FIG. 3 in a cross-sectional view. The V-type ribs 23 formed on the disk body 22 are provided with a corrosion-protection layer 16.

Although the present invention was described above with reference to preferred embodiments, it is not limited to these embodiments, but instead can be modified in various ways.

In the preceding embodiment, the invention was illustrated with reference to a generator free-running pulley. The present invention, however, is not limited to this embodiment, but instead can be modified in many respects and can obviously also be transferred to other systems and applications.

It is understood that the specified sizes, quantities, temperatures, pH values, etc., can also be varied, without diverging from the essence of the invention. It is also understood that any passivation bath known in the state of the art could be used. Thus, for example, cobalt could be added to the electrolyte solution. It is further possible to add, for example, tensides or protective colloids to the passivation bath, without affecting the invention.

### LIST OF REFERENCE SYMBOLS

10 Substrate
11 Zinc-bearing layer
12 Passivation layer, corrosion layer
13 Nanoparticle
14 Arrangement for protecting a substrate from corrosion
15 Surface of arrangement 14
16 Corrosion-protection layer
17 Passivation bath
21 Generator free-running pulley
22 Disk body
23 V-type rib

1. Arrangement for protecting a substrate from corrosion, comprising a substrate with an electrically conductive corrosion-protection layer deposited on the substrate for protecting the substrate from corrosion, the corrosion-protection layer has a zinc-bearing layer deposited on the substrate and a passivation layer deposited on the zinc-bearing layer for passivating the zinc-bearing layer, wherein the passivation layer has a plurality of hard-material particles, which increase a coefficient of friction of a free surface of the passivation layer is increased compared with a conversion layer without hard-material particles, and electrical conductivity of the passivation layer remains essentially unchanged.

2. Arrangement according to claim 1, wherein the hard-particle materials are constructed as nanoparticles.

3. Arrangement according to claim 2, wherein the nanoparticles have a size of 1-1000 nm, preferably 2-100 nm.

4. Arrangement according to claim 1, wherein the hard-material particles are made from inorganic hard material.

5. Arrangement according to claim 1, wherein the hard-material particles have a Mohs' hardness of at least 5.

6. Arrangement according to claim 1, wherein the hard-material particles are constructed as inorganic carbides, oxides, or nitrides, selected from the group consisting of SiO₂, SiC, WC, Al₂O₃, diamond, or BN, or mixtures thereof.

7. Arrangement according to claim 1, wherein the passivation layer has a thickness of at most 800 nm.

8. Arrangement according to claim 1, wherein the passivation layer comprises a chromium-bearing passivation layer.

9. Arrangement according to claim 1, wherein the substrate comprises steel or a steel alloy.

10. A pulley comprising:
a metallic body, which has a hub for precise-fit holding of a shaft,
an outer surface on a periphery thereof for holding a belt made from a polymer material,
a substrate of the metallic body at least in a region of an outer surface of the pulley, including an electrically conductive corrosion-protection layer deposited on the substrate for protecting the substrate from corrosion, the corrosion-protection layer has a zinc-bearing layer deposited on the substrate and a passivation layer deposited on the zinc-bearing layer for passivating the zinc-bearing layer, wherein the passivation layer has a plurality of hard-material particles which increase a coefficient of friction of a free surface of the passivation layer compared with a conversion layer without hard-material particles, and electrical conductivity of the passivation layer remains essentially unchanged.

11. Pulley according to claim 10, wherein the pulley is constructed as a V-ribbed pulley or as a straight disk.

12. Method for creating a passivation layer comprising the steps:
(a) preparing of a passivation bath, which has hard-material particles,
(b) preparing a substrate having a surface on which a zinc-bearing layer is deposited,
(c) immersing the substrate in the passivation bath, by which a passiviation layer is formed on the surface of the zinc-bearing layer, wherein the passivation layer has a plurality of hard-material particles, and forming the passivation layer with an increased coefficient of friction of a free surface of the passivation layer due to the hard-material particles compared with a passivation layer without hard-material particles, and an electrical conductivity of the passivation layer remains essentially unchanged.

13. Method according to claim 12, wherein before the step (a), preparing a passivation solution in which the hard-material particles are introduced for generating the passivation bath.

14. Method according to claim 12, further comprises flushing the passivation layer generated in step (c) flushed in another step (d).

15. Method according to claim 14, further comprising drying the passivation layer after the step (c) or after the step (d) or after both steps (c) and (d).

16. Method according to one claim 12, wherein the passivation bath contains a chromium-bearing passivation solution.

17. Method according to claim 12, wherein the passivation bath is provided essentially free from chromium (VI).
